(19) United States
(12) Patent Application Publication
(10) Pub. No.: US 2007/0216600 A1
(43) Pub. Date: Sep. 20, 2007

(54) PORTABLE INTERACTIVE DISPLAY SYSTEM

(75) Inventor: Daniel Langlois, Montreal (CA)

Correspondence Address: BROUILLETTE & PARTNERS, METCALFE TOWER, 1550 METCALFE STREET, SUITE 800, MONTREAL, QC, H3A-1X6, CA

(73) Assignee: PIXMAN CORPORATION, Montreal, Quebec (CA)

(21) Appl. No.: 10/596,299

(22) PCT Filed: Nov. 30, 2004
(86) PCT No.: PCT/CA04/02061

§ 371 Date: Mar. 30, 2007

(30) Foreign Application Priority Data
Dec. 2, 2003 (CA) 2451877

(51) Int. Cl. G09G 5/00

(52) U.S. Cl. 345/8

(57) ABSTRACT

The invention relates to portable interactive display systems, which may be used with for instance advertising using multimedia presentations. Past portable display systems have not allowed the audience to interact with the display in an effective manner. The device of the invention is configured to be mounted on the human body with a general support frame (20) while displaying a video image from a display (70). A carrying sack (40) contains media generating means. An input device allows the audience to interact with the display system to play video games or use software applications, wherever the display system may be.

The present invention relates to a portable interactive display system. The system of the invention can be used, for example, as an advertising device executing audiovisual presentations and applications making use of digital image files, digital video files, and/or digital audio files.

Various methods for advertising exist today in abundance. Many of the more common methods of advertising include billboards and signs, which are posted in locations frequented by many people. These methods of advertising while useful have a significant drawback in that they require large amounts of space. There is therefore a limited amount of signs and billboards which can be placed in an area before the area becomes saturated. Furthermore, signs and billboards often require significant effort to change advertising should one desire replace an old advertisement with a new advertisement.

Other less frequent methods of advertising include wearable signs which are carried by a human operator in a populated area. This method solves some of the problems of space which are involved with normal signs and billboards, though the wearable signs can often be quite uncomfortable for the wearer. Additionally the wearable signs are still static and need to be replaced if a new advertisement is desired.

Recently as technology has progressed, and miniaturisation techniques have been improved, several types of portable electronic devices have been made available. These sort of devices include a range of devices from portable telephones to personal computer which can be mounted on a person's body. Examples of these kinds of devices can be seen in for instance U.S. Pat. No. 6,140,981 to Kuenster et al., and U.S. Pat. No. 6,057,966 to Carroll et al.

There have also been attempts at including video images on garments, see for example U.S. Pat. No. 5,912,653 to Stephan Fitch. This device while allowing changeable images on a person, are not useful for large scale advertising since the display has to be of reduced weight to prevent tearing of the garment.

As can be seen from the prior art there is a need for a portable interactive display device which can be used for large scale advertising and audiovisual presentations.

### SUMMARY OF THE INVENTION

The interactive display system transforms an audience that is normally passive into an active audience. Users are able to use the interactive display system to play video games or use software applications, wherever the display system may be.

More particularly, the interactive display system comprises:
a display device (visual medium): Flat-LCD weather-resistant & sun-viewable display.
a media generating means (powerful medium): Powered by a DVD player, it enables high-resolution video content playback and remote selection/control. Powered by a video game console or a portable computer, it enables execution of video games and software applications on the move.
a command means (interactive medium): It is possible to interact with the DVD player with standard commands of a remote control (change tracks, volume, etc.) with the help of an added infra-red communications link. It is possible to interact with a video game by using wired or wireless game pads linked to the game console installed in the display system backpack. It is possible to interact with a software application by using a gyroscopic mouse which responds to movement in the air and a wireless keyboard linked to a computer installed in the display system backpack.
a wireless communication means (wireless medium): Network connection: wireless connection to the Internet/LAN/WAN via cellular or Wi-Fi access points. Local connection: wireless connection to an interactive tool (game pad, mouse, keyboard, remote control) used by the users or of the display system.
a sound system (audible medium): High-quality stereo sound system with adjustable volume.
an operator (human medium): Product sampling, collaterals distribution, live subscriptions, human interaction. The operator is human, which makes it possible to follow intelligent scenarios.
a display system (nomadic medium): Moves to reach the crowds at specific times in targeted locations.

### BRIEF DESCRIPTION OF THE DRAWING

FIG. 1 is a side view of one embodiment of a portable interactive display system according to the present invention.

FIG. 2 is a front view of a support structure according to the embodiment of the invention shown in FIG. 1.

FIG. 3 is a diagram of the interior of a backpack of the embodiment of FIG. 1.

FIG. 4 is diagram of a second embodiment of the present invention.

FIG. 5 is a diagram of the interior of a backpack of the embodiment of FIG. 4.

FIG. 6 is a diagram of the embodiment of the invention shown in FIG. 1.

FIG. 7 is a perspective view of the invention according to the embodiment shown in FIG. 1, shown without a display device.

FIG. 8 is a perspective view of the invention according to the embodiment shown in FIG. 4, shown without a display device.

FIG. 9 is a perspective view showing an embodiment of the display system shown in FIG. 1.

FIG. 10 is another perspective view showing an embodiment of the display system shown in FIG. 1.

FIG. 11 is another perspective view showing a backpack comprised in the display system shown in FIG. 1.

FIG. 12 is a schematic diagram showing an embodiment of the display system shown in FIG. 1.

### DETAILED DESCRIPTION OF THE PREFERRED EMBODIMENTS

In one aspect, as shown in FIG. 1, the present invention relates to a portable interactive display system 10. The portable interactive display system 10 comprises a general support frame 20, on which is mounted a base support means 30, and a carrying sack 40. A support member such as a hollow tube 50 is attached at one end to the base support means 30. At the other end of hollow tube 50 is mounted a connecting means 60 which is used to attach display device 70 to the hollow tube 50.

The carrying sack 40 contains a media generating means (see below) which is connected to the display device 70 by a cable means 80, which allows for the media generating device to send a generated image to the display device 70 which can then show the image.

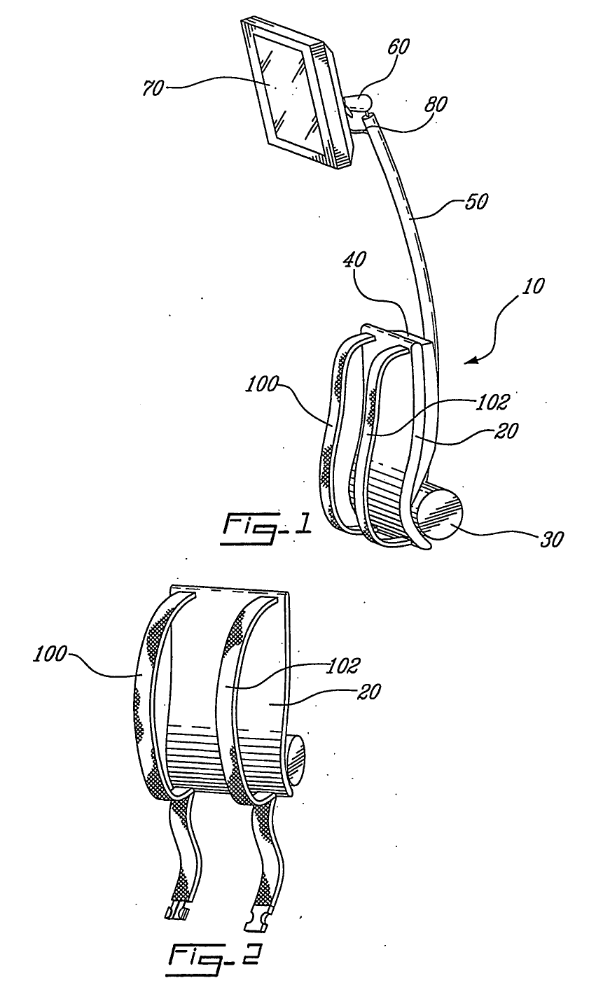

As can be seen in FIG. 2, the general support frame 20 comprises a body which is generally vertically extending as a plate member or optionally, which is made of a structure including two lateral bars which are held together by upper and lower bars (not shown). The general support frame 20 also has straps 100 and 102 which can be used to fasten the general support frame 20 to the body of a person.

It is illustrated in FIG. 1 how a general support frame 20 may have a curvature adapted to fit to the natural curvature of a person's body. This allows for greater comfort while carrying the device.

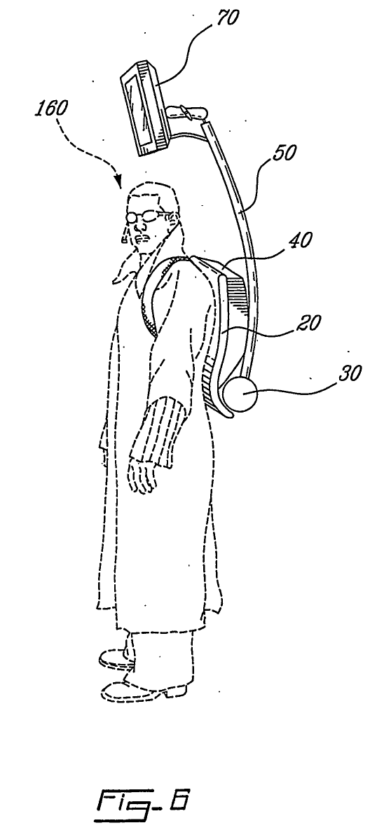

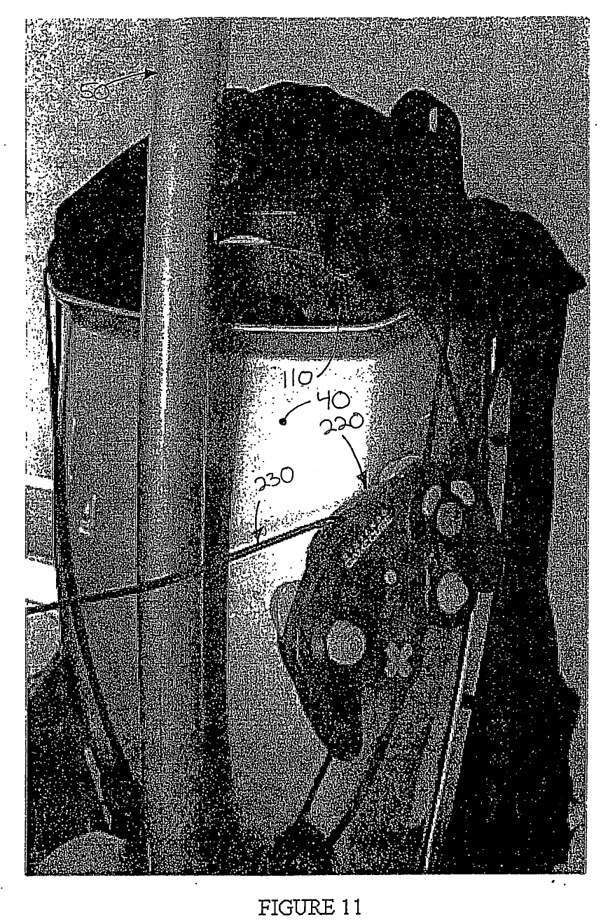

The backpack 40 may be made from a hard plastic shell, and may contain batteries, a media generating means (e.g. a computer gaming system, a computer equipped with internet communication means, a DVD player or a portable computer), and speakers. One example of the contents of the backpack 40 may be seen schematically in FIGS. 3, 5 and in FIG. 11. The media generating means 110 generates and image that may be based on a video program which can be stored on a storage means being readable by the media generating means 110. Also, the media generating means 110 includes means to provide on the display device 70 an interactive interface such as internet, video games, local software application, network access, short message service (SMS) and multimedia messaging services (MMS).

In FIGS. 3 and 6, the media generating means 110 is connected to the display device 70, and the speakers 120 such that the media generating means 110 can play back a video program from a storage means (e.g. a DVD disk or a MPEG-2 file) on the display device 70, may offer an interface for internet services, video games or interactive software and play sounds using the speakers 120. The speakers may also be placed on either end of the base support means 30.

The backpack 40, also contains a battery 130 or some other power supply which powers the speakers 120 and the display device 70. The media generating device 110 may have its own internal power supply or be powered by the battery 130.

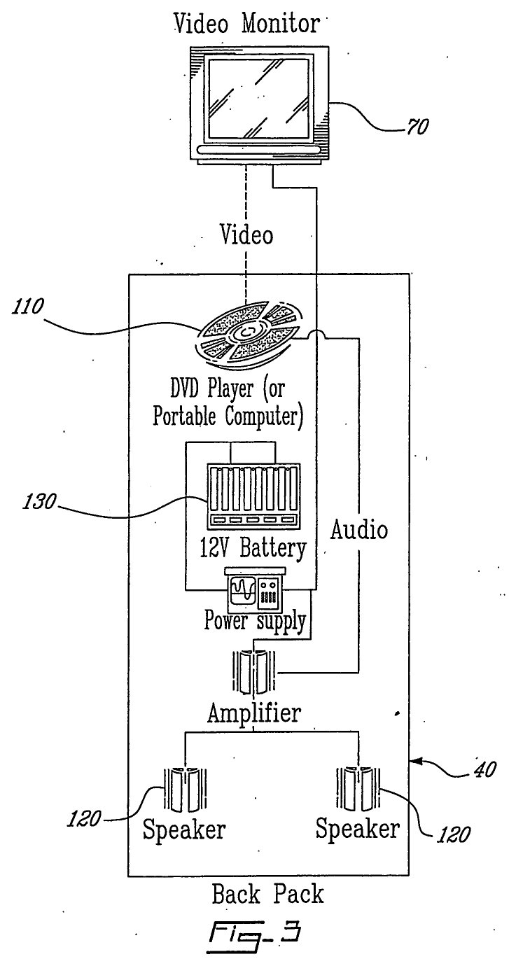

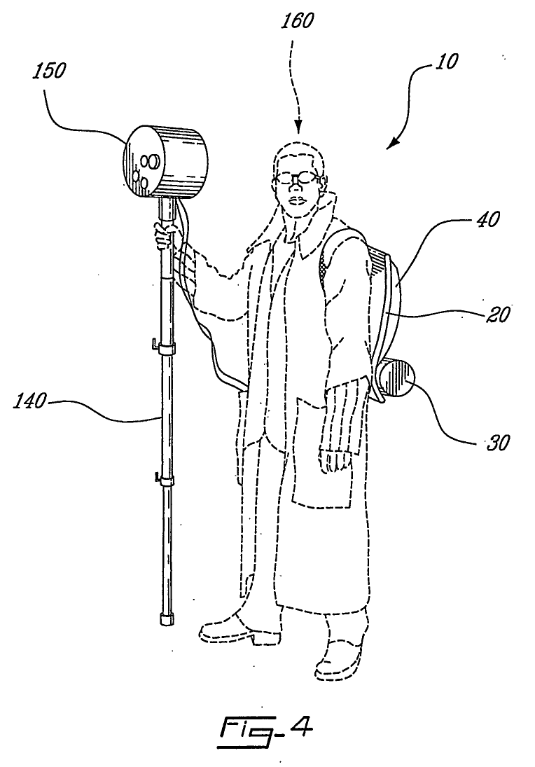

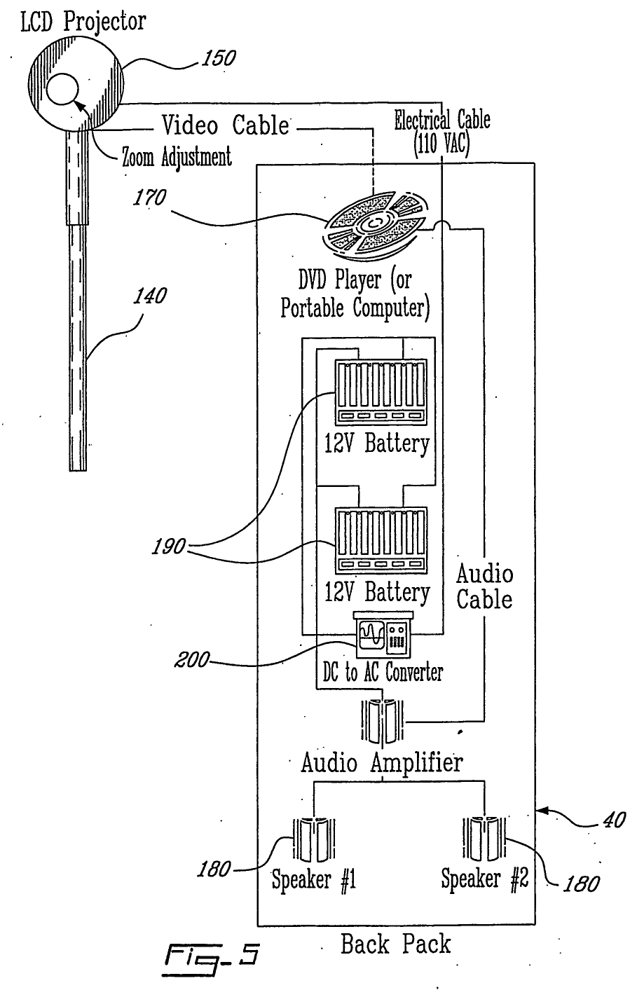

In another embodiment shown in FIGS. 4 and 5, the display device 70 and the hollow tube 50 may be replaced by a telescopingpole 140 and projector 150. In this embodiment a media generating means stored in the backpack 40, will use the projector 150 to project images for viewing by an audience or simply act as a display interface for the interactive functions provided by the media generating device, as described hereinabove. The projector 150 may be mounted on a telescoping pole 140 such that an operator 160 can carry the projector 150 or support the projector on the ground via the telescoping pole 140.

FIG. 5 shows a diagram schematizing the contents of the backpack 40 in the case where a projector 150 is used. In this embodiment the backpack 40, may contain a media generating means 170, such as a computer gaming system, a computer equipped with internet communication means, a DVD player or a portable computer. The media generating means 170 generates an image based on a video program stored on a storage means, for instance a DVD disk or a video file, or may provide means to display or achieve to the projector 150 an interactive interface for internet services, video games or interactive software. The media generating means 170 is connected to the projector 150 such that said image generated by the media generating means 170 is projected by the projector 150.

Additionally, the media generating means 170 is connected to a pair of speakers 180 such that an audio component generated by said media generating means 170 can be played back on said speakers.

The backpack 40, also may contain a pair of batteries 190 which power the projector 150 and the speakers 180. The media generating means 150 may have a separate power source or may be connected to the batteries 190. The backpack 40, may also include a DC to AC converted 200 if a AC driven projector is used.

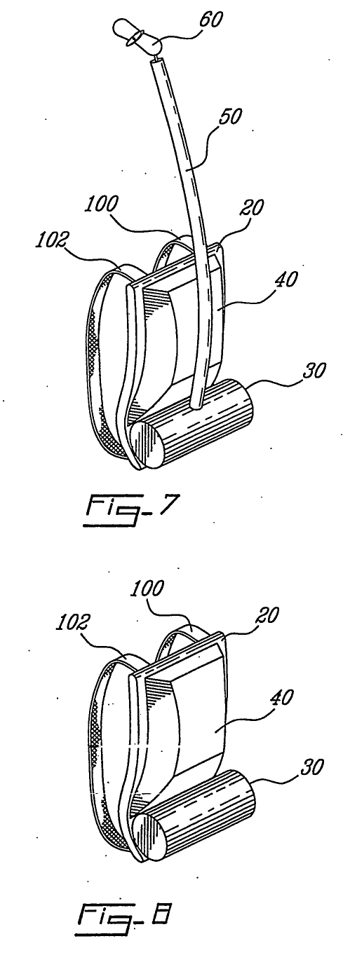

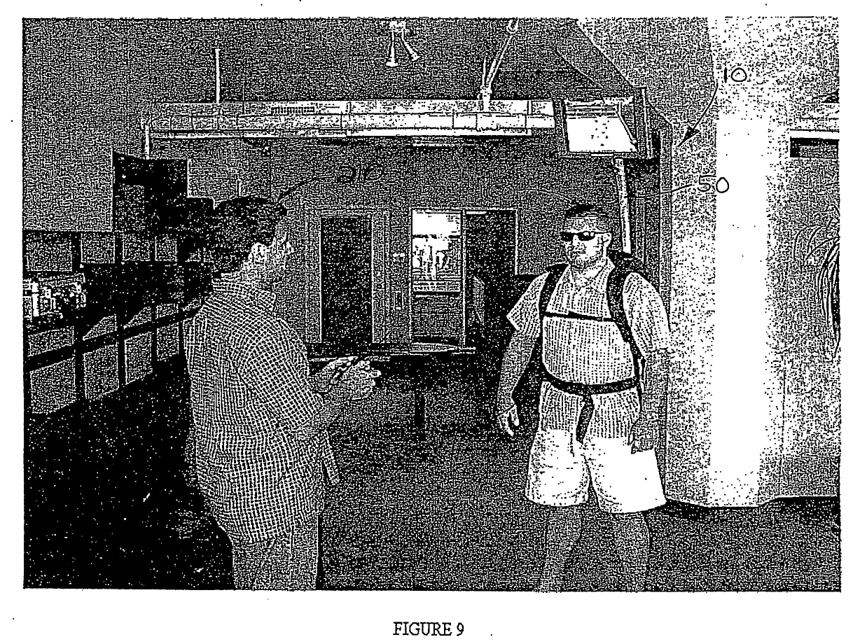

One embodiment of the display system 10 which provides an interactive interface is shown in more details in FIGS. 9, 10 and 11. This embodiment is shown with the media generating means 110 connected to the display device 70 shown in FIGS. 1, 3, 6, 7 and 8, but could be used with the generating means 170 and the projector 150 described in the embodiment of FIGS. 4 and 5.

An operator 160 carries the display system 10 and maintains a position as to enable a user 210 to have an access to what is being displayed on the display device 70. In the shown embodiment, the display device 70 is attached to the hollow tube 50 above the head of the operator 160 and displays a video game interactive interface to the user 210. The media generating means 110 is a video game console which is held in the carrying sack 40 and played by the user 210 with a command means 220.

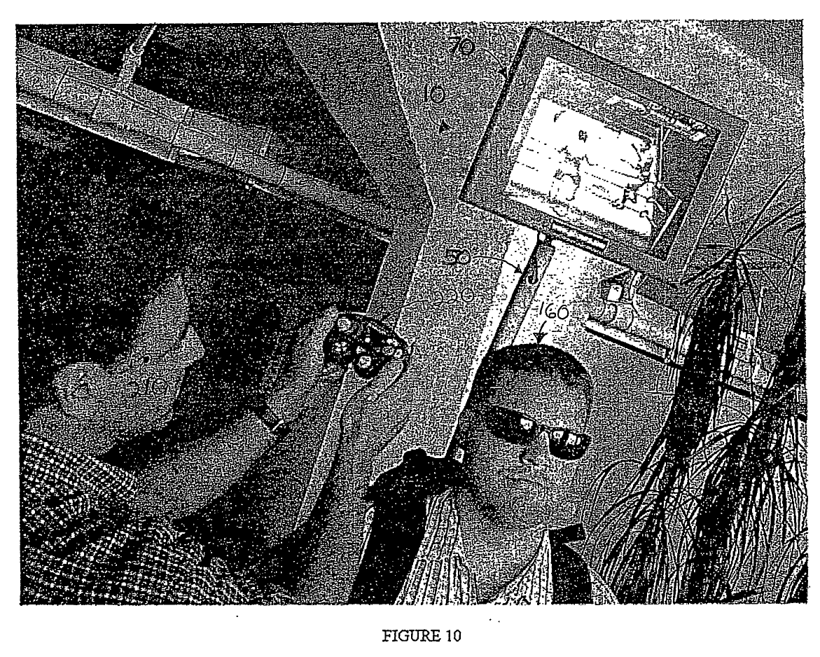

The command means 220 in communication with the media generating means 110 of the display system 10 may be selected from a wide variety of devices such as a remote control, a game pad, a keyboard, a mouse, a touch screen, a joystick, a phone or a microphone. Also, the command means 220 may be in communication with the media generating means 110 via wires 230 (FIG. 9) or via wireless technologies (FIG. 10) involving links such as cellular/mobile links and Wi-Fi (IEEE 802.11b) links, infra-red links (IR) and radio-frequency links (RF). IR links generally require line of sight with the component for which the signal is sent, but RF links generally do not require line of sight and are able to pass through the backpack 40 fabric or material.

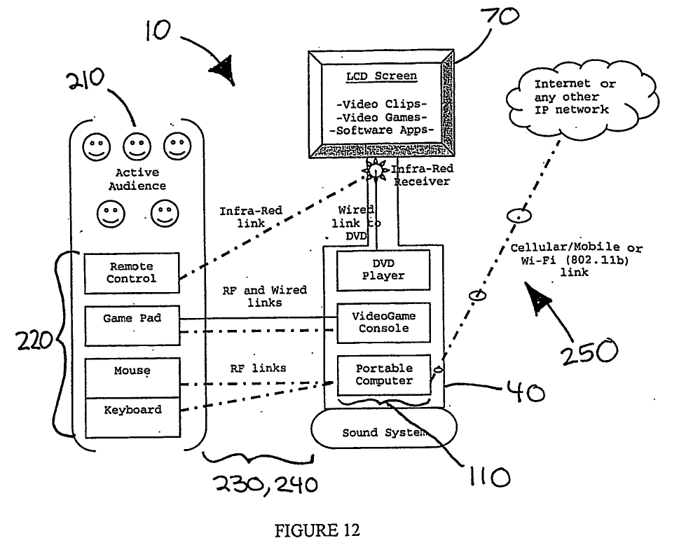

FIG. 12 schematically illustrates how the display system 10 interactively integrates users 210 in using the display system 10 to have access to its various components and functionalities. The users 210 are provided with the command means 220 to interactively operate any media generating means 110 carried by the backpack 40 through wires 230, wireless technologies 240 and a wireless communication means 250. The media generating means 110 then uses the display device 70 as an output responding to the input command expressed by the user 210 through the command means 220. Having access to the output message generated on the display device 70, the user 210 may respond with another input command, and so on. The input command/output message sequences generate interactivity between the user 210 and the display system 10.

The operator 160 (see FIGS. 9 and 10) carries the display system 10 such that he may also interact in real time during the interactivity between the user 210 and the display system 10. For instance, the operator 160 may move or orient the display system 10, make adjustments to the sound and image of the display system 10, talk to the user 210, help the user 210, give information or advices to the user 210.

Therefore, by using the command means 220, the user interactively uses the display system 10 to play with a video game, to surf the internet, to have access to local software applications or to have network accesses, to use short message services (SMS) and multimedia messaging services (MMS), to be in communication with another user 210 using the display system 10, or to be in communication with a user equipped with or having access to a corresponding display device 70/media generating means 110 technology. Those interactive applications offered by the display system 10 will be further discussed hereinafter.

The launch and promotion of products such as video games can be done on the move in public places with the display system 10. Most video games retailers don't advantage one game or gaming system against the others and thus, each brand is demonstrated in a fixed location, side by side in the stores and is displayed only to people entering the store. Using the display system 10, gaming publishers and manufacturers can reach targeted audiences and let them play targeted or selected games in places where no other option is presented. The display system 10 intends to develop adaptors and applications that will support gaming functionalities with most popular gaming technologies available.

Also, local software applications running on a computer located in the backpack 40 may also be provided by the display system 10. A software designing company selling products may wish to demonstrate software applications or offer products to customers using a small portable computer and a wireless mouse/keyboard in the display system 10. This offering will be interesting for business-to-business promotions in trade show and private meeting environments. The wireless mouse/keyboard used on the display system 10 may also respond to gyroscopic movements in the air which allows the user to stand in front of the display device 70 and control the application while avoiding the need for a table to operate it.

Another application of the display system 10 concerns network accesses. The network access applications include wireless technology, intranet and internet applications. Embodiments considered to network access applications via the display system 10 includes: PC cards (such as Sierra Wireless' Air Card) and Wi-Fi (or 802.11b), the latter being already included in many new laptop computers. PC Cards cover the same range as cellular/mobile networks, thus enabling connections almost everywhere at low speeds (60-120 Kbps). Wi-Fi offers high speeds (10 Mbps), but is only available in venues where Wi-Fi stations have been deployed, such as convention centers, campuses and hotels. For example, these network applications included in display systems 10 located in a convention center enables a team of operators 160, each equipped with a display system 10, to roam the floor showing tickers that are updated live by a centralized control room or website.

Still another application offered by the display system 10 includes the provision to the user 210 of short message services (SMS) and multimedia messaging services (MMS). The SMS has been available for a few years and with the increase capabilities of wireless technologies, the MMS has been added to the wireless offering of most network operators and is presently enabled on the new digital multimedia mobile phones. SMS and MMS are two wireless network applications that the display system 10 may offer in order to enable communications between phones (command means 220) used by the user 210 and the display device 70, using the media generating means 110 as an interface to ensure transposition between the two.

Also, the user 210 may be offered to be put in communication with another user 210 using the display system 10 at another location, or to be in communication with a user equipped with or having access to a corresponding display device 70/media generating means 110 technology using: a wireless communication means 250, a media generating means such as a portable computer, a command means 220 such as a phone or microphone and a display device 70.

In another aspect the invention includes an out-of-home audiovisual presentation method comprising:

a) the use of a nomadic technology to provide the ability:
a. to present audiovisual content in a moving fashion;
b. to target the time of the presentation;
c. to target the geographical area and the venues in which the content is presented;
d. to present interactive means for the user of the nomadic technology

b) a human being wearing audiovisual equipment providing the ability:
i) to rapidly change the time or location of the presentation;
ii) to interact with the audience verbally or with signs;
iii) to distribute and hand out collateral materials directly to passersby;
iv) to react to interactive use of the nomadic technology

c) the use of commercially available equipment to enable:
1. reproduction of existing broadcast quality and multimedia content in the MPEG-2 encoding format;
2. playback from any DVD that can be read with a commercial DVD player;
3. playback from any software application that can run on a commercial portable computer;
4. display of any visual content fit for television or computer screens;
5. projection of any visual content for television or computer screens;
6. display of a video game;
7. display internet services;
8. display interactive software applications and network accesses;
9. display interactive short message services (SMS) and multimedia messaging services (MMS);
10. display of an interactive communication between different users;
11. display of an interactive communication with a user equipped with corresponding technology.

In another embodiment the invention may be a wearable and nomadic technology comprising:

a) a costume customizable to each specific activity and facilitating the integration to a specific event or product brand, comprising;
i) a long trench coat designed for hiding the backpack straps;
ii) a hat of round form;
iii) pants to be worn under the trench coat;
iv) semi-transparent mask and gloves;
b) a video monitor perched over the character's head on top of an inverse-T aluminum structure with the following specifications: i) a direct sunlight 1 viewable LCD display of suitable size;
ii) a marine compliant (NEMA 4×) seal casing for watertight protection;
iii) video inputs compatibility: Standard VGA/SVGA/XGA, Composite Video, S-Video;
iv) resolutions: preferably 800×600 pixels, up to 1280×1024 pixels;
v) on-screen display menu for video adjustments: position, size, brightness, contrast, etc.;

c) a backpack for the monitor set-up made of a hard plastic shell and containing:
i) an inverse-T structure made of aluminum tubes
ii) a low voltage DC audio amplifier (for example 10-watts), and two speakers (for example 10-watts) located on each side of the character's waist in the two extremities of the horizontal tube;
iii) one or more batteries, weighing as little as possible, and a low voltage DC regulated power supply;
iv) a commercial type portable DVD player, a video game console or a portable Windows-compatible computer, both having external audio and video output ports;
v) communication means in communication with the display system.

d) a video projector standing on a telescopic pole which may be held by the character at different heights and in different positions, with the following specifications:
i) a LCD projector;
ii) very light weight;
iii) native resolution: true XGA 1024×768 or better;
iv) data compatibility: all standard VESA modes, VGA, SVGA, XGA, and SXGA 85 Hz;
v) video compatibility: Full NTSC (M 4.43), PAL (BGHI, M, N), SECAM (M), HDTV (720p and 1080i RGBHV);

e) a backpack for the projector set-up made of a hard plastic shell containing:
i) a light weight tube attached at the bottom of the backpack in the horizontal position;
ii) a low voltage VDC audio amplifier, and two speakers located on each side of the character's waist;
iii) one or more batteries as light as possible, and a DC to AC electrical converter;
iv) a commercial type portable DVD player or a portable Windows-compatible computer, both requiring external audio and video output ports and their own battery pack.

While the invention has been described in relation to several embodiments it will be apparent to those skilled in the art that several modifications and variations not mentioned exists. Accordingly the previous descriptions are only meant for the purposes of illustration, and are not meant to limit the scope of the invention.

1) A portable display system arranged to be carried and manipulated by a human operator, said portable display system comprising:
a. a display device capable of displaying an output message;
b. a media generating means connected to said display device and capable of generating an output message;
c. power supply means able to provide electrical power to said portable display system;
d. a transport means adapted to transport said media generating means and said power supply means and adapted to be carried by said human operator, said transport means comprising:
i. a support frame;
ii. a plurality of fastening means;
e. a command means for generating an input command from a user, said user being different from said human operator and said command means being connected to said media generating means;
wherein said output message displayed by said display device and generated by said media generating means can be interactively modified upon the generation of said input command.

2) A portable display system as claimed in claim 1, further characterized in that said transport means further comprises:
a. a base support means fixedly mounted to said support frame;
b. a carrying sack fixedly mounted to said support frame.

3) A portable display system as claimed in claim 1, further characterized in that said transport means further comprises:
a. an elongated support member having first end and second end, said second end being fixedly attached to said support frame;
b. mounting means for attaching said display device to said elongated member first end.

4) A portable display system as claimed in claim 2, further characterized in that said transport means further comprises:
a. an elongated support member having first end and second end, said second end being fixedly attached to said base support means;
b. mounting means for attaching said display device to said elongated member first end.

5) A portable display system as claimed in claim 1, wherein said display device is a liquid crystal display (LCD) screen.

6) A portable display system as claimed in claim 1, wherein said media generating means comprises media processing means.

7) A portable display system as claimed in claim 6, wherein said media generating means further comprises a digital media player.

8) A portable display system as claimed in claim 1, wherein said media generating means comprises:
a. a digital media player;
b. media processing means.

9) A portable display system as claimed in claim 8, wherein said digital media player is a digital versatile disk (DVD) player.

10) A portable display system as claimed in claim 6, wherein said media processing means is a game console or a portable computer.

11) (canceled)

12) A portable display system as claimed in claim 10, wherein said command means connected with wires or wirelessly to said game console or to said portable computer.

13) (canceled)

14) A portable display system as claimed in claim 12, wherein said command means are a joystick or a game pad or a remote control or a gyroscopic mouse or a keyboard or a touchscreen.

15) (canceled)

16) (canceled)

17) (canceled)

18) (canceled)

19) (canceled)

20) (canceled)

21) A portable display system as claimed in claim 10, further comprising wireless communication means connecting said game console or said portable computer to a computer network.

22) (canceled)

23) A portable display system as claimed in claim 21, wherein said wireless communication means is a Radio-Frequency (RF) communication system or a cellular communication system or a Wi-Fi communication system.

24) (canceled)

25) (canceled)

26) (canceled)

27) (canceled)

28) (canceled)

29) A portable display system as claimed in claim 1, wherein said portable display system further comprises a sound generating means connected to said media generating means.

30) A portable display system as claimed in claim 29, further comprising speakers connected to said sound generating means.

31) (canceled)

32) (canceled)

33) A portable display system as claimed in claim 1, further comprising short message service (SMS) and multimedia message service (MMS) interface means connected to said media generating means.

34) A portable display system as claimed in claim 2, wherein said carrying sack is a shell made of rigid material.

35) A portable display system as claimed in claim 34, wherein said rigid material is a hard plastic.

36) A portable display system as claimed in claim 1, further comprising:
a. an telescopic pole having first end and second end;
b. mounting means for attaching said display device to said telescopic pole first end;
wherein said telescopic pole can be used by said human operator to carry said display device or to support said display device on the ground.

37) (canceled)

38) A portable display system as claimed in claim 36, wherein said display device is a projector.

39) A method for using the portable display system as described in claim 1, said method comprising the step of:
a. attaching said frame support to said human operator using said fastening means;
b. said human operator wearing said portable display system;
c. said human operator walking to an audience, said audience comprising a plurality of potentials users;
d. said human operator handing said command means to one of said users;
e. said user sending an input message to said media generating means using said command means;
f. said media generating means generating an output message to said display device according to said input message sent by said user using said command means;
g. said display device displaying said output message.
